(19) United States
(12) Patent Application Publication
(10) Pub. No.: US 2006/0287934 A1
(43) Pub. Date: Dec. 21, 2006

(54) Method of and system for monitoring real time market data

(76) Inventor: Marshall R. Rowe III, Chicago, IL (US)

Correspondence Address: MCCRACKEN & FRANK LLP, 200 W. ADAMS STREET, SUITE 2150, CHICAGO, IL, 60606, US

(21) Appl. No.: 11/156,741

(22) Filed: Jun. 20, 2005

(51) Int. Cl. G06Q 40/00

(52) U.S. Cl. 705/35

(57) ABSTRACT

A method of monitoring real time market data includes identifying a category of market data, calculating a result for the category of market data, and at least one of graphically displaying the result in real time and providing an audible indication of the result in real time.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates generally to monitoring real time market data such as, for example, market updates, market depth changes, settlements, indicative prices and deltas, volatilities, interest rates, and messages.

2. Description of the Background of the Invention

Real time delivery of various market information is integral to the decision making process of many players within the financial industry. Therefore, many information services provide such market information via multicast feeds to numerous subscribers. This market information may originate from various financial environments such as open-outcry sources, electronic exchanges, and the Dow Jones, and may be transmitted to various traders and investors. It is helpful to monitor these market data to ensure that the multicast feeds are operating properly. In addition, traders and investors may use results calculated from these market data to track various activity levels within the market.

In one method of monitoring and displaying such market information, an intermediary system supplies a client with desired information on financial products. A financial delivery computer is placed between client terminals and a plurality of financial institutions and comprises a service selection/execution unit, financial institution data, and client data files. Upon receipt of a product selection request from a client terminal, the service selection/execution unit retrieves client preference information, which is stored in the client data files, and searches the financial institution data based on the retrieved preference information.

Another such method includes a securities trading workstation, which is integrated into a network of competing market makers for a plurality of securities. The workstation receives data on current market events for the securities and supplies these data to seven separate applications running on the workstation. The applications allow a user to track the market, select securities, bid and ask pricing, market direction, and market depth. The user may also enter a transaction order using the workstation.

### SUMMARY OF THE INVENTION

According to one aspect of the invention, a method of monitoring real time market data includes identifying a category of market data, calculating a result for the category of market data, and at least one of graphically displaying the result in real time and providing an audible indication of the result in real time.

According to yet another aspect of the invention, a system for monitoring real time market data includes a source for providing real time market data and a sensor in data communication with the source, wherein the sensor subscribes to a category of market data and published the market data to a bus. A computer is in data communication with the sensor and has an application running thereon, wherein the application calculates a result based on the market data and performs at least one of graphically displaying the result in real time and providing an audible indication of the result in real time.

Other aspects and advantages of the present invention will become apparent upon consideration of the following detailed description, wherein like reference numbers in the various drawings designate like structures in the various embodiments.

### BRIEF DESCRIPTION OF THE DRAWINGS

FIG. 1 depicts one embodiment of a system for monitoring real time market data in accordance with the present invention;

FIG. 2 illustrates one embodiment of a method of monitoring real time market data using the system of FIG. 1;

FIG. 3 illustrates a further embodiment of a method of monitoring real time market data using the system of FIG. 1; and

FIG. 4 is a graphical user interface display for displaying one or more results according to the present invention.

### DETAILED DESCRIPTION

The present invention is directed to methods and systems for monitoring real time market data. While the present invention may be embodied in many different forms, several specific embodiments are discussed herein with the understanding that the present invention is to be considered only as an exemplification of the principles of the invention, and it is not intended to limit the invention to the embodiments illustrated.

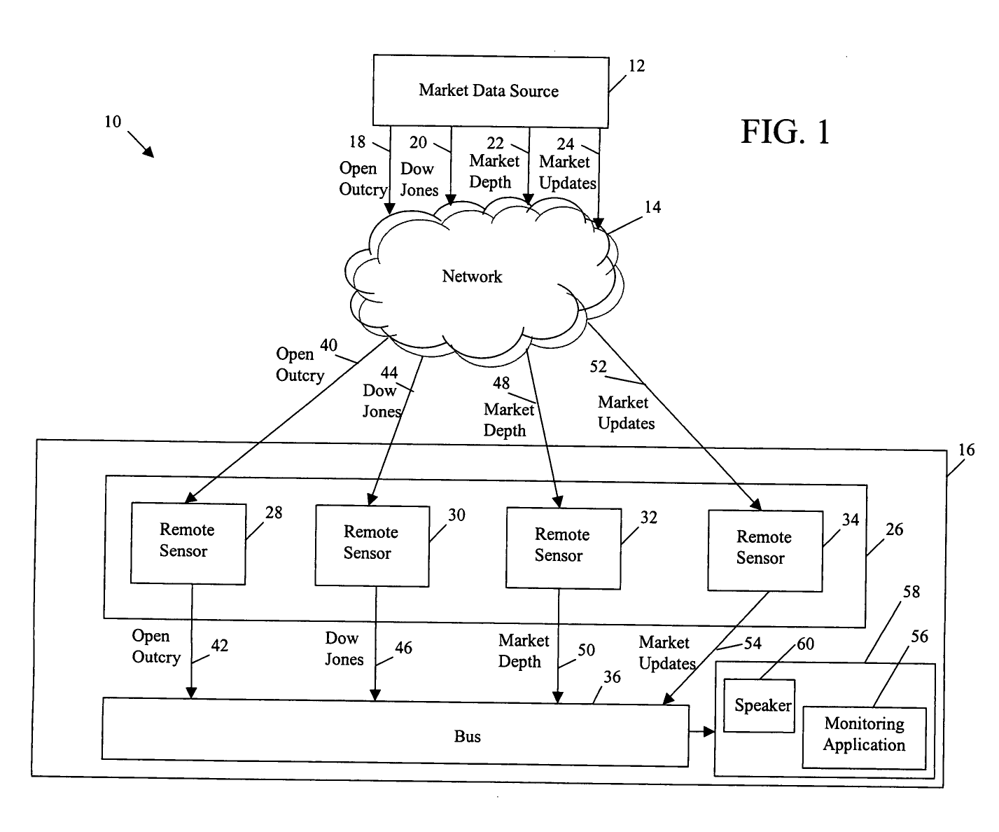

Referring now to the drawings, FIG. 1 shows one embodiment of a system 10 in which real time market information is monitored. The system 10 includes at least one source for providing market information. Although additional sources may be utilized, the system 10 of FIG. 1 includes a single source for providing market information 12. The system 10 further includes a network interface 14 through which the market information is transmitted and a local system 16 that receives and monitors the market information.

In one embodiment, the market information source 12 comprises any system that distributes real time market data including, but not limited to, market updates, market depth changes, settlements, indicative prices and deltas, volatilities, interest rates, and messages. The market data may be distributed in any form or format and may comprise numerous data packets. One system that may be utilized is, for example, TDI™ Feed. TDI™ Feed is a product/service offered by CMS Webview plc of London, U.K., that provides tailored high speed, wholesale feeds of real time data from the world's leading futures exchanges to subscribing users around the world.

The network interface 14 may comprise a local area network, wide area network, internet, intranet, extranet, proprietary network, virtual private network, a TCP/IP-based network, wireless network, or a combination of one or more of the foregoing, for facilitating communication between the market information source 12 and the local system 16. In one embodiment, the network interface 14 supports multicasting, which is the process of transferring a single message to multiple recipients simultaneously. Multicasting allows for transmitted information to be divided into categories and provides users the ability to subscribe to one or more of the categories, according to their needs. As a result, and according to one embodiment of the present invention, multicasting allows users to subscribe to all market data that is transmitted or one or more categories of the market data. A network interface having such capabilities is RadianzNet, an extranet provided by Radianz of New York, N.Y.

Various market feeds or categories of market data are distributed by the market information source 12 and subscribed to by the local system 16, including data representing open outcry market data 18 and data representing indices from Dow Jones 20. The local system 16 may also subscribe to data representing market depth 22, wherein market depth data include, for example, buy and sell orders for a particular contract or security. In addition, the local system 16 may subscribe to data representing market updates 24, wherein data representing market updates include, for example, current price and quantity data for stocks, bonds, indices, foreign exchanges, options, futures, and the like.

The local system 16 may be implemented by a quote vendor, trading company, or any other entity that subscribes to the multicast data feeds distributed from the market information source 12. The local system 16 may include a transmission system 26 having one or more remote sensors such as, for example, 28, 30, 32, and 34. The remote sensors 28, 30, 32, and 34 are software applications that communicate with the market information source 12 via the network interface 14. The sensors 28, 30, 32, and 34 read and write data packets transmitted by the source 12 using an application programming interface (“API”) such as Smartsockets software, available from Tibco Software, Inc. of Palo Alto, Calif.

According to one embodiment, the remote sensor 28 subscribes to and reads data representing open outcry data 40 from market information source 12 and writes data representing open outcry data 42 to a bus 36 within the local system 16. The remote sensor 30 subscribes to and reads data representing indices from Dow Jones 44 from market information source 12 and writes data representing indices from Dow Jones 46 to the bus 36. The remote sensor 32 subscribes to and reads data representing market depth 48 from market information source 12 and writes data representing market depth 50 to the bus 36. The remote sensor 40 subscribes to and reads data representing market updates 52 from market information source 12 and writes data representing market updates 54 to the bus 36.

The transmission system 26, utilizing the sensors 28, 30, 32, and 34, may process the market data 42, 46, 50, and 54 into a form and format suitable for use by a monitoring application 56. One such form and format conforms to Inter-Exchange Technical Committee (ITC) Specification Version 2.1, which may be found at www.cbot.com/cbot/docs/52987.pdf and is expressly incorporated by reference herein. Other methods and systems apparent to those skilled in the art for transmitting, receiving, and processing market data may additionally or alternatively be implemented.

The monitoring application 56 is a software application that may be running on a computer 58 within or in communication with the local system 16. The application 56 reads the market data that is published to the bus 36 and extracts therefrom market information for monitoring and for calculating a result. The application 56 may graphically display the result on a display screen of the computer 58 and/or provide an audible indication of the result via a speaker 60.

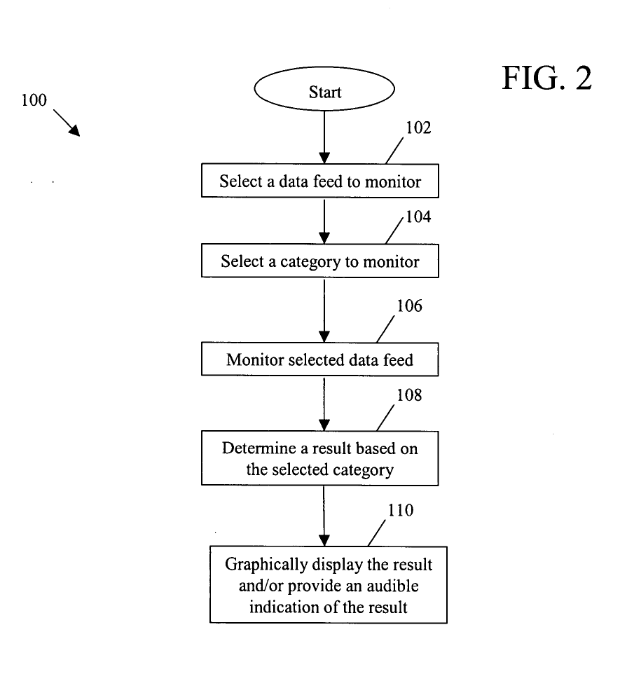

According to FIG. 2, one method of monitoring real time market data using the system of FIG. 1 is shown generally at 100. Block 102 selects a data feed for monitoring. Various data feeds may include, for example, an open outcry data feed, a Dow Jones indices data feed, a market depth data feed, and a market updates data feed. Block 104 selects a category for monitoring with respect to the selected data feed. The category may be any user-defined category relevant to the data transmitted via the data feeds and may range from a broad category, such as all contracts (i.e., traded products), to a narrow category, such as all orders involving September wheat.

Block 106 monitors the selected data feed and extracts data corresponding to the selected category. Block 108 calculates a result for the selected category. The result may comprise a flow rate, such as, for example, data packets per second, or a count of market data packets received from the data feed that corresponds to the selected category. Alternatively, the result may comprise a volume of trading activity, a ratio, a running average, or any other result derived from the data feed by various calculations. Results may be calculated continuously or at any desired time interval.

Once the result has been determined, block 110 provides at least one of a graphical representation of the result in real time or an audible indication of the result in real time. The graphical representation of the result may comprise a flow or dial meter, or alternatively, may comprise a graph, such as a bar graph, a chart, a diagram, or any other desired graphical representation. The graphical representation may be updated continuously or at any desired time interval. The graphical representation may further include color. Different colors may be provided within different value ranges of the graphical representation to characterize results corresponding to that range. For example, a result that corresponds to a red value range may indicate an unacceptable value, whereas a result that corresponds to a green area may indicate an acceptable value.

The audible indication may comprise any sound or wave file. The application 38 of FIG. 1 may be configured to provide different sounds for different results or may be configured to alter a characteristic, such as volume, of a sound when the result changes or reaches a predetermined threshold. The audible indication may be updated continuously or at any desired time interval. In addition, the audible indication of the result may be provided alone or in conjunction with a graphical representation of the result.

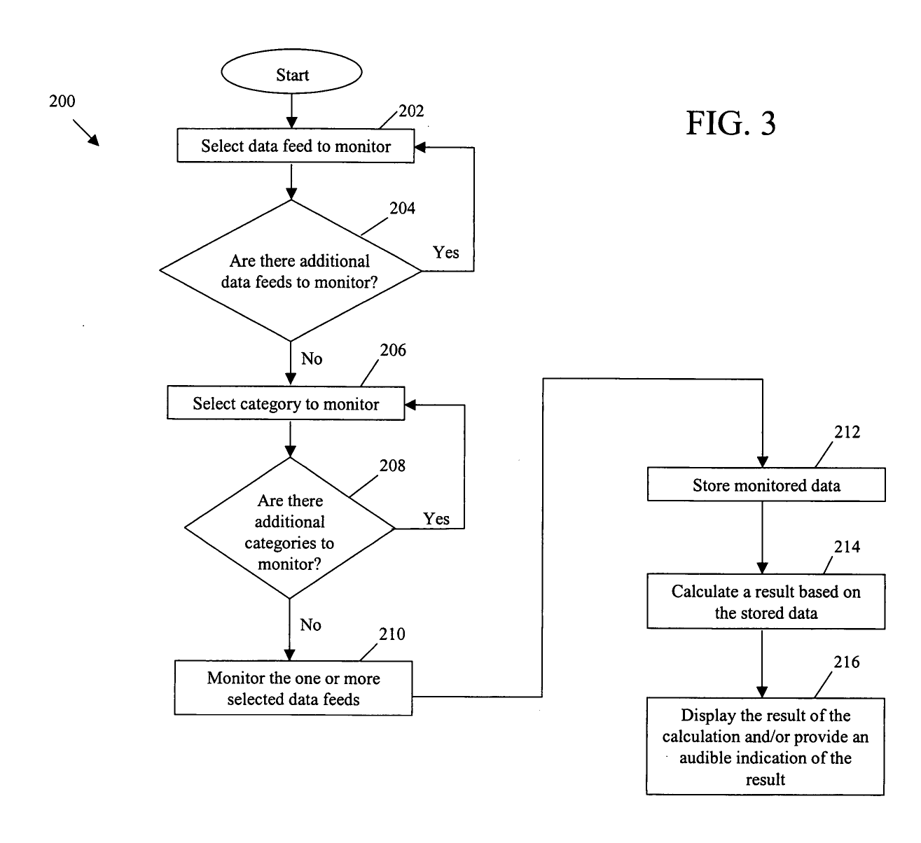

Turning now to FIG. 3, an alternative method of monitoring real time market data using the system of FIG. 1 is shown at 200. Block 202 selects a data feed to monitor. Various data feeds, as discussed above, may include an open outcry data feed, a Dow Jones indices data feed, a market depth data feed, and a market updates data feed. Block 204 determines if there are additional data feeds to monitor. If additional data feeds exist, control passes back to block 202 so that additional data feeds may be selected for monitoring. If no additional data feeds exist, control continues to block 206.

Block 206 selects a category of data to monitor with respect to the one or more selected data feeds. Block 208 determines if there are any additional categories of data to monitor. If additional categories exist, control passes back to block 206 so that additional categories may be selected for monitoring. If additional categories do not exist, control continues to block 210. Therefore, if desired, one or more categories may be monitored simultaneously, wherein each category may differ in breadth.

Block 210 monitors the one or more selected categories of data for the one or more selected data feeds. Block 212 stores the relevant data pertaining to the monitored categories of data so that calculations may be performed on the data, if desired. The data may be stored in any computer storage media, including, but not limited to, RAM, ROM, CD-ROM, digital versatile disk (DVD) or other optical disk storage, magnetic cassettes, magnetic tape, magnetic disk storage, or other magnetic storage devices, or any other medium that can be used to store the desired information and which can be assessed by a computer. Block 214 performs calculations based on the monitored categories of data from the one or more data feeds to produce one or more results. The results may comprise, for example, a volume of trading activity, a ratio, a running average, or any other derived result. Results may be calculated continuously or at any desired time interval.

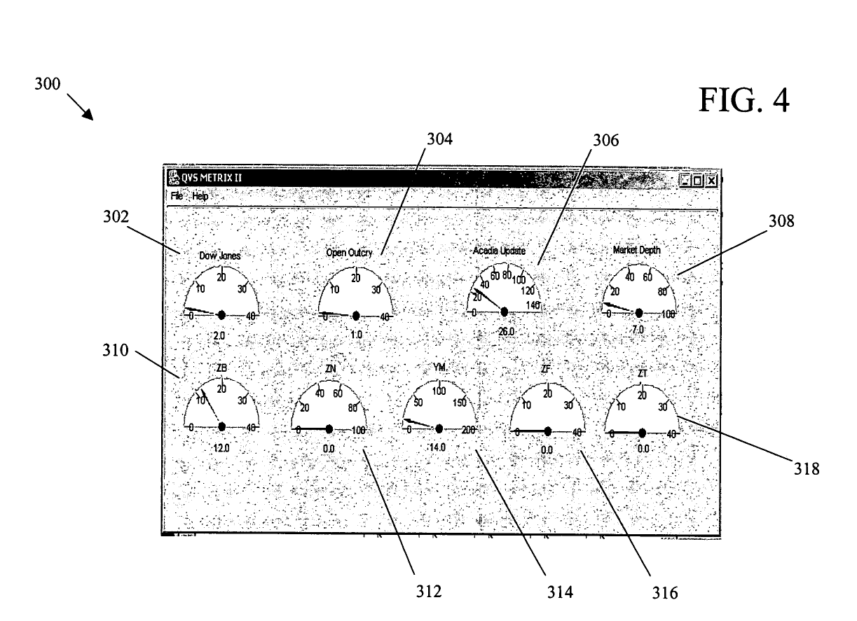

Graphical representations or, more specifically, flow meters useful in one embodiment of the present invention are shown generally at 300 in FIG. 4. Flow meters representing the total volume of data received from a Dow Jones indices data feed, an open outcry data feed, a market updates data feed, and a market depth data feed are shown at 302, 304, 306, and 308, respectively. Additional flow meters 310, 312, 314, and 316 are shown at 300. The flow meter 310 shows the volume for category “ZB” of data received from one or more of the data feeds 302, 304, 306, and 308, wherein “ZB” represents 30-year treasury bonds. The flow meter 312 shows the volume for category “ZN” of data received from one or more of the data feeds 302, 304, 306, and 308, wherein “ZN” represents 10-year treasury notes. The flow meter 314 shows the volume for category “YM” of data received from one or more of the data feeds 302, 304, 306, and 308, wherein “YM” represents mini-sized DJIA, a product offered by the Chicago Board of Trade. The flow meter 316 shows the volume for category “ZF” of data received from one or more of the data feeds 302, 304, 306, and 308, wherein “ZF” represents 5-year treasury notes. The flow meter 318 shows the volume for category “ZT” of data received from one or more of the data feeds 302, 304, 306, and 308, wherein “ZT” represents 2-year treasury notes.

Flow meters useful in the present invention may further include more than one indicator to show, for example, history or trends for the selected category of data to be monitored. In addition, one or more numerical indications of values represented by each of the flow meters may be provided adjacent the flow meters.

A user may view the graphical representation and/or listen to the audible indications to ensure that a system such as, for example, the system 10 of FIG. 1 is operating properly. In addition, traders or investors may use these results to track the activity level for a specific category or to gauge how the activity levels of different categories compare to one another, and thereby use this information to make trading decisions.

The current system and method is directed to the monitoring and displaying of activity in financial exchanges. However, monitoring data packets transmitted over a channel, categorizing the data packets, and calculating and displaying a result for each category calculated using the number of packets related to the category that are transmitted during a time interval may have use in other environments.

### INDUSTRIAL APPLICATION

The method of monitoring real time market data of the present invention can be used to monitor real time market data to ensure that data reporting functions are operating properly. In addition, traders may use results calculated from this market information to track various activity levels or to gauge how activity levels compare to one another.

The invention has been described in an illustrative manner in order to enable a person of ordinary skill in the art to make and use the invention, and the terminology used is intended to be in the nature of description rather than of limitation. It is understood that the invention may be practiced in ways other than as specifically described, and that all modifications, equivalents, and variations of the present invention, which are possible in light of the above teachings and ascertainable to a person of ordinary skill in the art, are specifically included within the scope of the impending claims.

I claim:

1. A method of monitoring real time market data, the method comprising the steps of:
identifying a category of market data;
calculating a result for the category of market data; and
at least one of graphically displaying the result in real time and providing an audible indication of the result in real time.

2. The method of claim 1, wherein the result comprises a flow rate for the category of market data.

3. The method of claim 1, further comprising the step of providing real time market data.

4. The method of claim 3, further comprising the step of subscribing to a set of data from the real time market data.

5. The method of claim 4, wherein the set of data is data representing market indices.

6. The method of claim 4, wherein the set of data is data representing market depth.

7. The method of claim 4, wherein the set of data is data representing market updates.

8. The method of claim 4, wherein the set of data is data representing open outcry market data.

9. The method of claim 1, wherein the category is a traded product.

10. The method of claim 9, wherein the traded product is a contract.

11. The method of claim 1, wherein the calculating step is performed continuously.

12. The method of claim 1, wherein the step of at least one of graphically displaying the result and providing an audible indication of the result is performed continuously.

13. The method of claim 1, wherein graphically displaying the result comprises displaying a flow meter.

14. A system for monitoring real time market data comprising:
a source for providing real time market data;
a sensor in data communication with the source, wherein the sensor subscribes to a category of market data and publishes the market data to a bus;
a computer in data communication with the bus and having an application running thereon, wherein the application calculates a result based on the market data and performs at least one of graphically displaying the result in real time and providing an audible indication of the result in real time.

15. The system of claim 14, wherein the result comprises a flow rate for the category of market data.

16. The system of claim 14, wherein the real time market data represents a set of market data.

17. The system of claim 16, wherein the set of data is data representing market depth.

18. The system of claim 16, wherein the set of data is data representing market updates.

19. The system of claim 16, wherein the set of data is data representing open outcry market data.

20. The system of claim 14, wherein graphically displaying the result includes displaying a flow meter.
